(19) United States
(12) Patent Application Publication
(10) Pub. No.: US 2008/0266355 A1
(43) Pub. Date: Oct. 30, 2008

(54) Inkjet head and manufacturing method thereof

(75) Inventors: Young-Seuck Yoo, Seoul (KR); Jae-Woo Joung, Suwon-si (KR); Young-Jae Kim, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 12/081,602

(22) Filed: Apr. 17, 2008

(30) Foreign Application Priority Data
Apr. 18, 2007 (KR) 10-2007-0037674

(51) Int. Cl. B41J 2/14; G11B 5/127

(52) U.S. Cl. 347/47; 216/27

(57) ABSTRACT

An ink-jet head and method of manufacturing the ink-jet head are disclosed. For an ink-jet head including a chamber containing an ink supplied through a channel, a membrane covering the chamber, and a nozzle jetting the ink, the manufacturing method may include forming the chamber by etching a portion of one side of a first substrate; forming the channel connected with the chamber by etching a portion of the other side of the first substrate; and bonding a second substrate to the one side of the first substrate such that the chamber is covered. This allows greater ease in manufacturing, while reducing the risk of damage in the wafer and increasing yield. Furthermore, the thickness of the chamber may be reduced regardless of the thickness of the chamber, which can improve the reaction speed to signals and improve frequency characteristics.

### CROSS-REFERENCE TO RELATED APPLICATIONS

This application claims the benefit of Korean Patent Application No. 10-2007-0037674 filed with the Korean Intellectual Property Office on Apr. 18, 2007, the disclosure of which is incorporated herein by reference in its entirety.

### BACKGROUND

1. Technical Field

The present invention relates to an ink-jet head and a method of manufacturing the ink-jet head.

2. Description of the Related Art

An ink-jet head is an apparatus for jetting droplets through a small nozzle by transforming electric signals to physical forces. For an ink-jet head, the size of the chamber has a major effect on the jetting performance.

In an ink-jet head according to a related art, such as that shown in FIG. 1, the volume of the chamber may depend also on the width or breadth of the chamber, but the range of values for the width or breadth is narrow, due to design limitations imposed by the piezoelectric element, i.e. the driving part, and the membrane. That is, in practice, the volume of the chamber may depend mainly on the thickness of the chamber.

An ink-jet head according to the related art may be fabricated by processing stainless steel, ceramic, or silicon wafers, etc. For stainless steel or ceramic, it may not be difficult to control the volume of the chamber, but an extra mold may be needed, and there may be difficulties in implementing design changes.

As such, methods of manufacturing ink-jet heads from silicon wafers are widely receiving attention, in which two or three single crystal silicon wafers may be fabricated to form each structure and then may be bonded together, as illustrated in FIG. 2.

In the related art, for the manufacturing of an ink-jet head by bonding two or three silicon wafers in which structures such as the chamber and membrane are formed, an SOI (Silicon-On-Insulator) may be used in order that the membrane and chamber may be integrated as a single body. That is, two silicon substrates having oxide layers formed on the surfaces can be bonded by silicon direct bonding (SDB), where the upper substrate can be polished to form the membrane, and the lower substrate can be etched to form the chamber.

The upper substrate manufactured by the method above may be bonded with another middle substrate and a lower substrate to complete the manufacture of an ink-jet head.

Therefore, in order to decrease the thickness of the chamber in an ink-jet head structure according to the related art, the thickness of the lower substrate may have to be decreased. However, assuming a limit of 200 micrometers as the limit in thickness that does not subject the silicon wafer to a risk of breaking, the thickness of the chamber cannot be decreased to below this limit using methods of the related art.

The volume of the chamber of an ink-jet head is correlated with the speed for reacting to a signal, where the lower the volume, the faster the reaction speed. This can affect the operating waveform of the ink-jet head, and as a lower volume of the chamber allows a faster operation, the frequency characteristics may be improved. However, as described above, there is a limit to lowering the volume of the chamber by decreasing the thickness of the chamber in the method of manufacturing an ink-jet head according to the related art.

### SUMMARY

An aspect of the invention provides an ink-jet head and a method of manufacturing the ink-jet head, which allows easier manufacturing processes, increases yield, improves reaction speeds to signals, and improves frequency characteristics.

Another aspect of the invention provides a method of manufacturing an ink-jet head that includes a chamber containing an ink supplied through a channel, a membrane covering the chamber, and a nozzle jetting the ink. The method includes forming the chamber by etching a portion of one side of a first substrate; forming the channel connected with the chamber by etching a portion of the other side of the first substrate; and bonding a second substrate to the one side of the first substrate such that the chamber is covered.

The first substrate and the second substrate may be silicon (Si) wafers.

The forming of the chamber may include forming an inlet connected with the channel by etching another portion of the first substrate.

Additionally, an operation of forming the membrane by polishing the second substrate may be performed after the bonding a second substrate to the one side of the first substrate.

Here, an operation of bonding a third substrate to the other side of the first substrate may be performed after the forming of the membrane, where a restrictor and a nozzle path may be formed in the third substrate, such that the restrictor may be connected with the channel, and the nozzle path may be connected with the chamber.

Also, an operation of bonding a fourth substrate to the third substrate may be performed after the bonding of the third substrate, where the nozzle may be formed in the fourth substrate that is connected with the nozzle path.

Yet another aspect of the invention provides an ink-jet head, which includes a chamber formed by etching a portion of one side of a first substrate, a channel connected with the chamber and formed by etching a portion of the other side of the first substrate, a membrane bonded to the one side of the first substrate such that the chamber is covered, and a second substrate bonded to the other side of the first substrate and in which a nozzle is formed connected with the chamber.

The first substrate and the second substrate may be silicon (Si) wafers.

The ink-jet head may further include an inlet connected with the chamber and formed by etching another portion of the first substrate.

Also, a third substrate may be interposed between the first substrate and the second substrate, where a restrictor and a nozzle path may be formed in the third substrate. The restrictor can be connected with the chamber, and the nozzle path can connect the chamber with the nozzle.

Additional aspects and advantages of the present invention will be set forth in part in the description which follows, and in part will be obvious from the description, or may be learned by practice of the invention.

### BRIEF DESCRIPTION OF THE DRAWINGS

FIG. 1 is an exploded perspective view of an ink-jet head according to the related art.

FIG. 2 is a cross-sectional view of an ink-jet head according to the related art.

FIG. 3 is a flowchart of a manufacturing method of an ink-jet head according to an embodiment of the present invention.

FIG. 4A, FIG. 4B, FIG. 4C, FIG. 4D, FIG. 4E, and FIG. 4F are cross-sectional views representing processes of a manufacturing method of an ink-jet head according to an embodiment of the present invention.

FIG. 5 is a cross-sectional view of an ink-jet head according to an embodiment of the present invention.

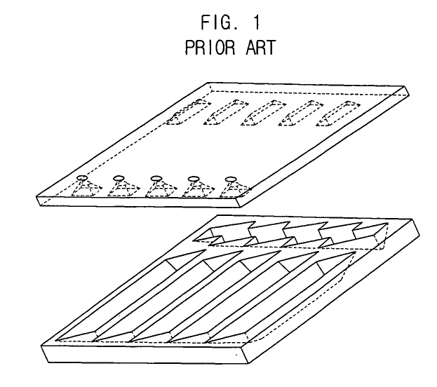

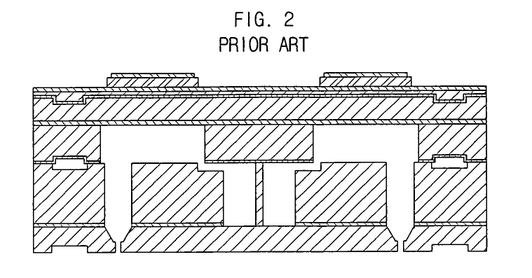

### DETAILED DESCRIPTION

The ink-jet head and manufacturing method thereof according to certain embodiments of the invention will be described below in more detail with reference to the accompanying drawings. Those components that are the same or are in correspondence are rendered the same reference numeral regardless of the figure number, and redundant explanations are omitted.

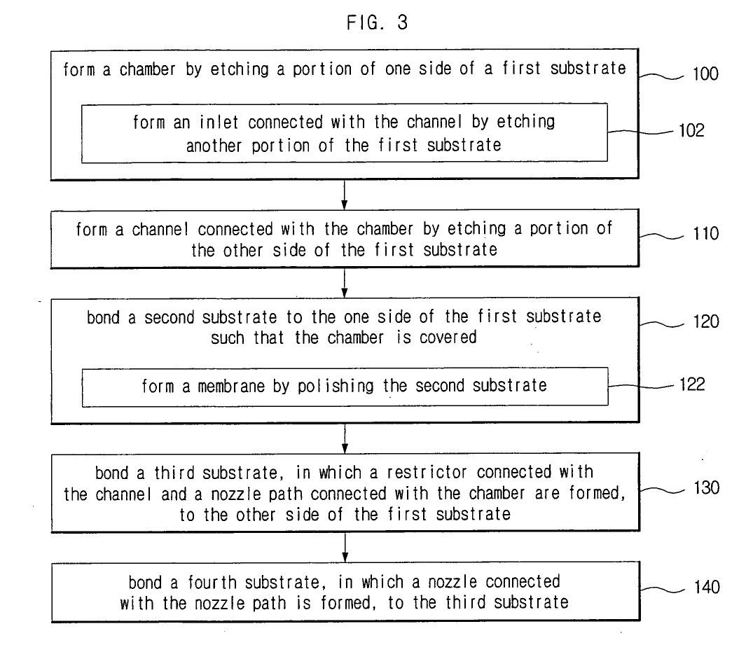

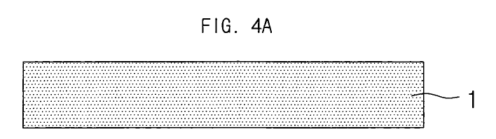

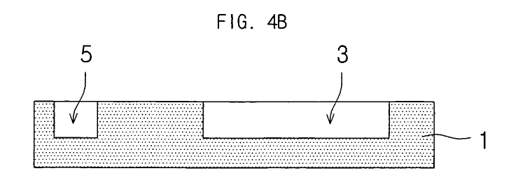

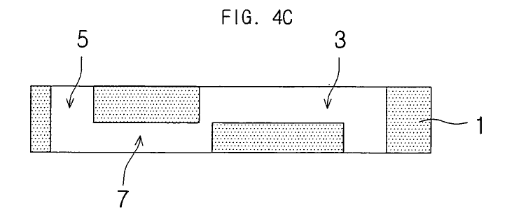

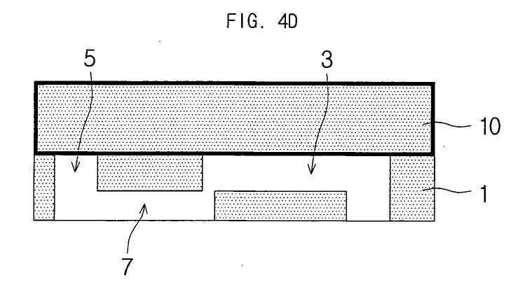

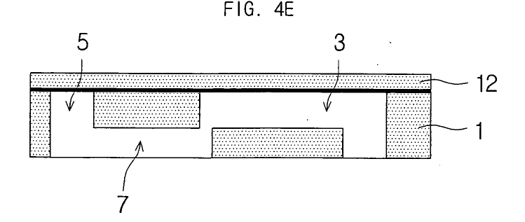

FIG. 3 is a flowchart of a manufacturing method of an ink-jet head according to an embodiment of the present invention, and FIG. 4A through FIG. 4F are cross-sectional views representing processes of a manufacturing method of an ink-jet head according to an embodiment of the present invention. In FIG. 4A through FIG. 4F are illustrated substrates 1, 10, a chamber 3, an inlet 5, a channel 7, and a membrane 12.

As described above, in the related art, photolithography may be used for patterning a chamber in a substrate such as a silicon (Si) wafer. This may generally entail various processes such as coating a photoresist (PR), aligning, exposing, developing, etching, and stripping the photo resist, etc. Here, when the thickness of the SOI wafer for forming a chamber and a membrane is below a particular value, the wafer may be broken in the process. That is, it is difficult to reduce the thickness and hence the volume of the chamber in methods of the related art that include perforating a silicon (Si) wafer to form a chamber.

In particular, with increases in the diameter of the silicon (Si) wafer from 4″ to 6″ or even 8″, a greater thickness may be required in correspondence with the larger diameters of the wafer. In manufacturing an ink-jet head according to this embodiment, however, the thickness of the chamber can be reduced even with an increase in the thickness of the wafer, since the structures of the ink-jet head may be processed in both sides of a silicon (Si) substrate 1.

In this particular embodiment, silicon wafers may be used as the substrates for forming the structures of an ink-jet head. However, the substrates are not limited to silicon wafers.

In order to manufacture an ink-jet head according to this embodiment, a silicon substrate 1 may be used, as shown in FIG. 4A. As shown in FIG. 4B, a chamber 3 may be formed, by etching a portion of one side of the substrate 1 in correspondence with the chamber 3 (S100).

Since the structures of the ink-jet head may be processed in both sides of the substrate 1 in this embodiment, other structures to be formed on the one side of the substrate 1, such as an inlet 5 connected with the channel 7, may additionally be formed (S102), as in the example shown in FIG. 4B. Furthermore, other structures may be formed on the one side of the substrate 1 if needed.

Next, as shown in FIG. 4C, a channel 7 connected with the chamber 3 may be formed, by etching a portion of the other side of the substrate 1 in correspondence with the channel 7 (S110). The channel 7 may serve as a passage for delivering ink supplied to the chamber 3 through the inlet 5. Also, the channel 7 may be connected with a restrictor, which can limit backflow of the ink, such that the pressure provided from the chamber 3 may be delivered to the nozzle.

In the related art, the channel 7 may be formed in the middle substrate or the lower substrate, not in the upper substrate in which the chamber 3 is formed. However, in this embodiment, the chamber 3 can be formed in the substrate in which the channel 7 is formed, so that the thickness of the chamber may be reduced even when a thick substrate is used. For example, the thickness of the chamber 3 can be less than 100 μm, even when the ink-jet head is made of a silicon wafer having a thickness of over 200 μm.

The fact that the thickness of the chamber 3 can be decreased by thus forming the chamber 3 and channel 7 in each side of one substrate 1, is made possible by first processing the structures such as the chamber 3, etc., and afterwards attaching the substrate 10 that will serve as the membrane 12, as will be described later. This is different from methods of the related art, in which the chamber is processed after attaching the substrate 10 that will serve as the membrane 12 onto the silicon substrate 1.

Next, as shown in FIG. 4D, the chamber 3 may be covered, by bonding another substrate 10 to the one side of the substrate 1 in which the chamber 3 is formed (S120). The substrate 10 can be used for forming a membrane 12. After bonding the substrate 10, the membrane 12 may be formed by polishing the substrate 10 (S122).

An actuator such as a piezoelectric element (PZT) can be joined to the membrane 12. When the membrane 12 receives a driving force from the actuator and undergoes vibration, a pressure may be applied to the ink contained in the chamber 3. The pressurized ink may be jetted through the nozzle in the form of droplets.

The membrane 12 may be in the form of a thin film bonded onto the substrate 1 such that the chamber 3 is covered. In such cases, the membrane 12 can be formed not only by bonding and polishing the substrate 10, but also by bonding a thin film directly.

After polishing the substrate 10, as shown in FIG. 4F, various structures of the ink-jet head may be formed, such as the inlet 5.

Through the operations of processing the substrate 1, an upper substrate 1 of the ink-jet head may be manufactured, which may include the inlet 5, channel 7, chamber 3, and membrane 12. Then, as described above, a middle substrate 20 and/or a lower substrate may be bonded on, to complete the manufacture of the ink-jet head.

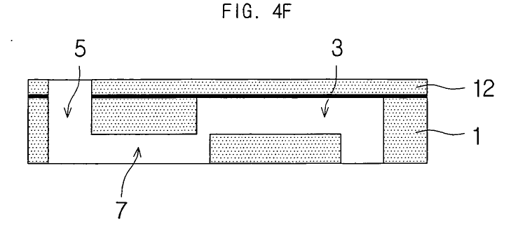

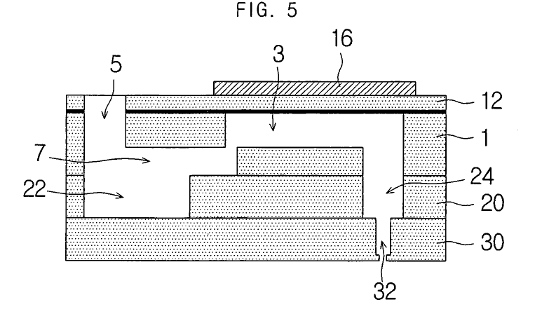

In the middle substrate 20, such as that shown in FIG. 5, there may be formed a restrictor connected with the channel 7 of the upper substrate 1, and a nozzle path connected with the chamber 3 of the upper substrate 1. If the middle substrate 20 is made of a silicon wafer, the upper substrate 1 and the middle substrate 20 may be bonded together by silicon direct bonding (SDB) (S130).

The lower portion of the middle substrate 20 may be joined with the lower substrate 30. In the lower substrate 30, the nozzle may be formed connected with the nozzle path of the middle substrate 20. If the lower substrate 30 is made of a silicon wafer, the lower substrate 30 and the middle substrate 20 may be bonded to each other by silicon direct bonding (SDB) (S140).

This particular embodiment relates mainly to a method of manufacturing the upper substrate 1 of an ink-jet head. The ink-jet head may be manufactured with multiple middle substrates, or may be manufactured by bonding the upper substrate 1 directly with the lower substrate 30 without the middle substrate 20, if all of the required structures have been formed.

FIG. 5 is a cross-sectional view of an ink-jet head according to an embodiment of the present invention. In FIG. 5 are illustrate substrates 1, 20, 30, a chamber 3, an inlet 5, a channel 7, a membrane 12, an actuator 16, a restrictor 22, a nozzle path 24, and a nozzle 32.

FIG. 5 presents an example in which the upper substrate 1 is manufactured according to the embodiment of the method of manufacturing an ink-jet head described above, and the middle substrate 20 and the lower substrate 30 are bonded to the upper substrate 1.

That is, in an ink-jet head according to this embodiment, the upper substrate 1 may be manufactured by processing both sides of one substrate. The chamber 3 may be formed by etching a portion of one side of the upper substrate 1, and the channel 7 connected with the chamber 3 may be formed by etching a portion of the other side of the upper substrate 1.

In addition, as set forth above, a membrane 12 may be bonded to cover the chamber 3, and the channel 7 may be formed, so that the upper substrate 1 may be manufactured.

An actuator 16 may be joined on the membrane 12 of the upper substrate 1, while a lower substrate 30 having a nozzle 32 connected with the chamber 3 may be bonded to a lower portion of the upper substrate 1, whereby the manufacture of the ink-jet head may be completed.

If necessary, a middle substrate 20 may be formed, which may include a restrictor 22 connected with the channel 7 and a nozzle path 24 connecting the chamber 3 with nozzle 32. The middle substrate 20 may be interposed between the upper substrate 1 and the lower substrate 30. The middle substrate 20 may be manufactured with one or more substrates.

The upper substrate 1, the middle substrate 20, and the lower substrate 30 can be made from silicon wafers, in which case the substrates may be bonded by silicon direct bonding (SDB).

As set forth above, by etching both sides of a silicon wafer to form the chamber and the channel, the chamber can be processed using a thicker silicon wafer, for greater ease in manufacturing. Also, the risk of damage in the wafer can be reduced, and yield can be increased. Furthermore, the thickness of the chamber may be reduced regardless of the thickness of the chamber, which can improve the reaction speed to signals and improve frequency characteristics.

While the spirit of the invention has been described in detail with reference to particular embodiments, the embodiments are for illustrative purposes only and do not limit the invention. It is to be appreciated that those skilled in the art can change or modify the embodiments without departing from the scope and spirit of the invention.

What is claimed is:

1. A method of manufacturing an ink-jet head comprising a chamber containing an ink supplied through a channel, a membrane covering the chamber, and a nozzle jetting the ink, the method comprising:
forming the chamber by etching a portion of one side of a first substrate;
forming the channel connected with the chamber by etching a portion of the other side of the first substrate; and
bonding a second substrate to the one side of the first substrate such that the chamber is covered.

2. The method of claim 1, wherein the first substrate and the second substrate are silicon (Si) wafers.

3. The method of claim 1, wherein the forming of the chamber comprises:
forming an inlet connected with the channel by etching another portion of the first substrate.

4. The method of claim 1, further comprising, after the bonding:
forming the membrane by polishing the second substrate.

5. The method of claim 4, further comprising, after the forming of the membrane:
bonding a third substrate to the other side of the first substrate,
wherein the third substrate has a restrictor and a nozzle path formed therein, the restrictor connected with the channel, and the nozzle path connected with the chamber.

6. The method of claim 5, further comprising, after the bonding of the third substrate:
bonding a fourth substrate to the third substrate,
wherein the fourth substrate has the nozzle formed therein, the nozzle connected with the nozzle path.

7. An ink-jet head comprising:
a chamber formed by etching a portion of one side of a first substrate
a channel connected with the chamber and formed by etching a portion of the other side of the first substrate;
a membrane bonded to the one side of the first substrate such that the chamber is covered; and
a second substrate bonded to the other side of the first substrate and having a nozzle formed therein, the nozzle connected with the chamber.

8. The ink-jet head of claim 7, wherein the first substrate and the second substrate are silicon (Si) wafers.

9. The ink-jet head of claim 7, further comprising:
an inlet connected with the chamber and formed by etching another portion of the first substrate.

10. The ink-jet head of claim 7, wherein a third substrate is interposed between the first substrate and the second substrate, the third substrate having a restrictor and a nozzle path formed therein, the restrictor connected with the chamber, and the nozzle path connecting the chamber with the nozzle.
